(19) United States
(12) Patent Application Publication
(10) Pub. No.: US 2006/0293432 A1
(43) Pub. Date: Dec. 28, 2006

(54) Fluorine-containing elastomer composition and molded article comprising the same

(75) Inventors: Seiichi Hirano, Osaka (JP); Tsuyoshi Noguchi, Osaka (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD.

(21) Appl. No.: 11/430,094

(22) Filed: May 9, 2006

(30) Foreign Application Priority Data
May 10, 2005 (JP) 2005-137843

(51) Int. Cl. B60C 1/00

(52) U.S. Cl. 524/493; 524/544; 525/326.2; 525/374

(57) ABSTRACT

The present invention provides a fluorine-containing elastomer composition containing a particular filler, and a molded article excellent in heat resistance obtained by crosslinking the composition. The present invention also provides a process for preparing a fluorine-containing elastomer composition comprising a step of preparing a surface-treated filler by treating a surface of a filler with a hydrophobic treatment agent so as to have a hydrophobization degree of at least 30% which is measured by the particular method. The present invention relates to a fluorine-containing elastomer composition comprising at least one kind of a crosslinking agent selected from the group consisting of an oxazole crosslinking agent, an imidazole crosslinking agent, a thiazole crosslinking agent and a triazine crosslinking agent, a fluorine-containing elastomer having a crosslinking site capable of a crosslinking reaction with the crosslinking agent, and a surface-treated filler in which a hydrophobization degree of the surface-treated filler is at least 30% which is measured by a particular method.

### BACKGROUND OF THE INVENTION

The present invention relates to a fluorine-containing elastomer composition containing a particular filler, and a molded article obtained by crosslinking the fluorine-containing elastomer composition. The present invention also relates to a process for preparing a fluorine-containing elastomer composition comprising a step of preparing a surface-treated filler by treating the surface of the filler with a hydrophobic treatment agent so as to have a hydrophobization degree of at least 30% which is measured by a particular method.

A fluorine-containing elastomer is molded into shapes such as an O-ring, a hose, a stem seal, a shaft seal and a diaphragm and is widely used in fields such as the automobile industry, the semiconductor industry and the chemical industry, due to the excellent heat resistance, chemical resistance, solvent resistance and fuel oil resistance thereof.

However, required properties become further severe along with progress of the technology and, in the aerospace space field, the field of semiconductor manufacturing equipment, the chemical plant field and the automobile industry, sealing property under an environment with a higher temperature which exceeds 200° C. is required, and molded articles or sealing materials obtained by peroxide crosslinking or polyol crosslinking, which have been conventionally used, are difficult to sufficiently satisfy to the requirement.

In view of such a problem, attempts are suggested to improve the required properties under a high temperature environment by devising crosslinking or devising an additive such as a filler. For example, a composition comprising a perfluoroelastomer and silicic acid anhydride, and an oxazole crosslinking agent, an imidazole crosslinking agent or a thiazole crosslinking agent (for example, see JP-A-2002-515525) is known. Since this composition contains an oxazole crosslinking agent, an imidazole crosslinking agent or a thiazole crosslinking agent, heat resistance is improved and, further, by adding silicic acid anhydride (SiO₂), generation of HF can be suppressed. However, since SiO₂ contains a large amount of functional groups on the surface, it is difficult to control a moisture amount and, further, there are problems that, due to hydrogen bonding of an active functional group (for example, —OH group) on the surface of SiO₂ with a part of the crosslinking agent, crosslinking inhibition occurs, curing is insufficient, or curing delay is caused.

In addition, a fluorine-containing elastomer composition comprising a fluorine-containing elastomer containing tetrafluoroethylene, perfluoro(alkyl vinyl ether), and cyano group-containing perflorovinyl ether, a specified silane coupling agent, an inorganic filler, and an oxazole crosslinking agent or an imidazole crosslinking agent (for example, see JP-A-2000-290454) is known. Regarding this composition, using silica as an inorganic filler is described, however, since the coupling agent and the inorganic filler are directly compounded at compounding in this process, there are problems that compression set is large and sufficient required properties can not be obtained.

Further, a particle diameter of a filler to be compounded is preferably small as an elastomer for a semiconductor from a viewpoint of controlling generation of contamination. However, compounding the filler having a smaller particle diameter caused a problem that the compression set becomes large and the heat resistance becomes inferior.

### SUMMARY OF THE INVENTION

The present invention provides a fluorine-containing elastomer composition containing a particular filler, and a molded article excellent in heat resistance obtained by crosslinking the composition. The present invention also provides a process for preparing a fluorine-containing elastomer composition comprising a step of preparing a surface-treated filler by treating the surface of the filler with a hydrophobic treatment agent so as to have a hydrophobization degree of at least 30% which is measured by a particular method.

Namely, the present invention relates to a fluorine-containing elastomer composition comprising at least one kind of a crosslinking agent selected from the group consisting of an oxazole crosslinking agent, an imidazole crosslinking agent, a thiazole crosslinking agent and a triazine crosslinking agent, a fluorine-containing elastomer having a crosslinking site capable of a crosslinking reaction with the crosslinking agent, and a surface-treated filler in which a hydrophobization degree of the surface-treated filler measured by the following method is at least 30%.

### Note

<Method of Measuring Hydrophobization Degree>

0.50 g (0.50±0.01 g) of a powdery sample is weighed and added to 100 mL pure water (water temperature at 20° C.) in a 500 mL beaker, and the mixture is stirred with a magnetic stirrer. A stirrer having a diameter of 5 mmφ and a length of 4 cm is used, and stirring is performed at a rotation speed of 500 rpm. Left after stirring for 5 minutes, the powdery sample floating on the water surface is confirmed, thereafter, methanol is added to the liquid surface at a rate of 20 g per minute. A point of time, when the powdery sample is dispersed in water and no sample is recognized on the liquid surface, is regarded as the end. An amount of methanol to be added is assumed to be A, and a hydrophobization degree is measured according to the following equation.
Hydrophobization degree (%)=A/(100+A)×100

The crosslinking agent is preferably at least one compound selected from the group consisting of a compound containing at least two crosslinkable reactive groups represented by the general formula (1): 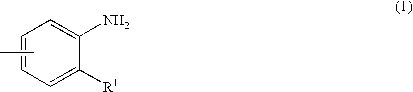
(wherein R¹ is the same or different, and is —NH₂, —NHR², —OH or —SH, and R² is a fluorine atom or a monovalent organic group), a compound represented by the general formula (2): 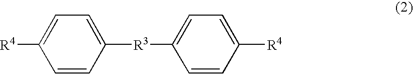
(wherein R³ is —SO₂—, —O—, —CO—, an alkylene group having 1 to 6 carbon atoms, a perfluoroalkylene group having 1 to 10 carbon atoms, or a single bond, and R⁴ is 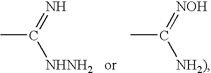
a compound represented by the general formula (3): 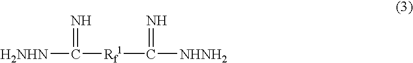
(wherein R_{f}¹ is a perfluoroalkylene group having 1 to 10 carbon atoms), and a compound represented by the general formula (4): 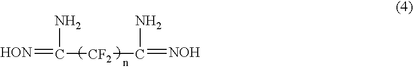
(wherein n is an integer of 1 to 10).

The fluorine-elastomer preferably has at least one group selected from the group consisting of a cyano group, a carboxyl group and an alkoxycarbonyl group.

The filler is preferably an inorganic filler.

The filler is preferably anhydrous silica.

The present invention also relates to a molded article which is obtained by crosslinking the fluorine-containing elastomer composition.

The present invention relates to a process for preparing a fluorine-containing elastomer composition comprising a step of preparing a surface-treated filler by treating a surface of a filler with a hydrophobic treatment agent so as to have a hydrophobization degree of at least 30% measured by the following method, and a step of mixing the surface-treated filler, at least one kind of a crosslinking agent selected from the group consisting of an oxazole crosslinking agent, an imidazole crosslinking agent, a thiazole crosslinking agent and a triazine crosslinking agent, and a fluorine-containing elastomer having a crosslinking site capable of a crosslinking reaction with the crosslinking agent.

### Note

<Method of Measuring Hydrophobization Degree>

0.50 g (0.50±0.01 g) of a powdery sample is weighed and added to 100 mL pure water (water temperature at 20° C.) in a 500 mL beaker, and the mixture is stirred with a magnetic stirrer. A stirrer having a diameter of 5 mmφ and a length of 4 cm is used, and stirring is performed at a rotation speed of 500 rpm. Left after stirring for 5 minutes, the powdery sample floating on the water surface is confirmed, thereafter, methanol is added to the liquid surface at a rate of 20 g per minute. A point of time, when the powdery sample is dispersed in water and no sample is recognized on the liquid surface, is regarded as the end. An amount of methanol to be added is assumed to be A, and a hydrophobization degree is measured according to the following equation.
Hydrophobization degree (%)=A/(100+A)×100

The hydrophobic treatment agent is preferably at least one treating agent selected from the group consisting of a silylating agent, a silicone oil, and a silane coupling agent.

Further, the present invention relates to a molded article, which is be obtained by crosslinking a fluorine-containing elastomer composition obtained by the preparation process.

### DETAILED DESCRIPTION

The present invention relates to a fluorine-containing elastomer composition comprising at least one kind of a crosslinking agent selected from the group consisting of an oxazole crosslinking agent, an imidazole crosslinking agent, a thiazole crosslinking agent and a triazine crosslinking agent, a fluorine-containing elastomer having a crosslinking site capable of a crosslinking reaction with the crosslinking agent, and a surface-treated filler, wherein a hydrophobization degree of the surface-treated filler is at least 30% which is measured by the method described later.

The surface-treated filler in the present invention is not particularly limited as long as a hydrophobization degree thereof is at least 30% which is measured by the method described later.

Examples of a filler used in the present invention are organic fillers such as a polyimide filler, and inorganic fillers, but it is preferable to use an inorganic filler in a viewpoint of the shielding effect of suppressing etching to an elastomer by various plasmas used in a semiconductor manufacturing equipment.

Examples of the inorganic filler are metallic fillers such as metal oxide, metal nitride, metal carbide, metal halide, metal sulfide, metal salt and metal hydroxide, and carbon fillers such as carbon black, graphitized carbon, and graphite.

Examples of the metal oxide are silicon oxide, barium oxide, titanium oxide, aluminum oxide, silver oxide, beryllium oxide, bismuth oxide, chromium oxide, boron oxide, cadmium oxide, copper oxide, iron oxide, gallium oxide, germanium oxide, hafnium oxide, iridium oxide, lanthanum oxide, lithium oxide, magnesium oxide, manganese oxide, molybdenum oxide, niobium oxide, neodymium oxide, nickel oxide, lead oxide, praseodymium oxide, rhodium oxide, antimony oxide, scandium oxide, tin oxide, strontium oxide, tantalum oxide, thorium oxide, vanadium oxide, tungsten oxide, zinc oxide, and zirconium oxide.

Examples of the metal nitride are lithium nitride, titanium nitride, aluminum nitride, boron nitride, vanadium nitride, and zirconium nitride.

Examples of the metal carbide are boron carbide, calcium carbide, iron carbide, manganese carbide, titanium carbide, silicon carbide, vanadium carbide, and aluminum carbide.

Examples of the metal halide are metal chloride and metal fluoride such as silver chloride, silver fluoride, aluminum chloride, aluminum fluoride, barium chloride, barium fluoride, calcium chloride, calcium fluoride, cadmium chloride, chromium chloride, cesium chloride, cesium fluoride, copper chloride, potassium chloride, potassium fluoride, lithium chloride, lithium fluoride, magnesium chloride, magnesium fluoride, manganese chloride, sodium chloride, sodium fluoride, nickel chloride, lead chloride, lead fluoride, rubidium chloride, rubidium fluoride, tin chloride, strontium chloride, thallium chloride, vanadium chloride, zinc chloride, and zirconium chloride, and bromide and iodide thereof.

The metal salt is represented by the formula: MₙAₘ (M is a metal, A is a residue of various inorganic acids, and m and n are integers which are suitably determined by respective valent numbers), and examples thereof are sulfate, carbonate, phosphate, titanate, silicate and nitrate of various metals. Specific examples are aluminum sulfate, barium carbonate, silver nitrate, barium nitrate, barium sulfate, barium titanate, calcium carbonate, calcium nitrate, calcium phosphate, calcium silicate, calcium titanate, cadmium sulfate, cobalt sulfate, copper sulfate, ferrous carbonate, iron silicate, iron titanate, potassium nitrate, potassium sulfate, lithium nitrate, magnesium carbonate, magnesium nitrate, magnesium silicate, magnesium titanate, magnesium carbonate, manganese sulfate, manganese silicate, sodium carbonate, sodium nitrate, sodium sulfate, sodium silicate, sodium titanate, nickel sulfate, lead carbonate, lead sulfate, strontium carbonate, strontium sulfate, strontium titanate, zinc carbonate, zinc sulfate, and zinc titanate.

Examples of the metal hydroxide are calcium hydroxide and magnesium hydroxide.

Examples of the metal sulfide are silver sulfide, calcium sulfide, cadmium sulfide, cobalt sulfide, copper sulfide, iron sulfide, manganese sulfide, molybdenum disulfide, lead sulfide, tin sulfide, zinc sulfide, and tungsten disulfide.

Among these, from viewpoints of small hygroscopicity and excellent chemical resistance, metal oxide is preferable, and from viewpoints of chemical resistance, chemical stability, and reinforcing property, silicon oxide is more preferable, and anhydrous silica is further preferable.

These fillers may be used by mixing at least two kinds thereof.

A filler may be particulate or fibrous (or in the state of whisker). In the case of the state of a particle, a diameter is not particularly limited, but from viewpoints of uniform dispersibility and the ability to form a thin film, it is preferably at most 5 μm, more preferably at most 1 μm, and further preferably at most 0.5 μm. The lower limit is determined by a kind of a filler.

In the present invention, this filler is treated on the surface by hydrophobization.

A hydrophobic treatment agent is used for the surface hydrophobization treatment. Examples of a hydrophobic treatment agent which can be suitably used in the present invention are a silylating agent, a silicone oil, and a silane coupling agent.

As the silylating agent, a silylating agent having a group represented by the general formula (5): 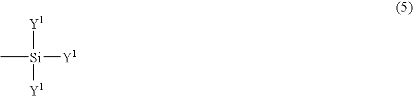
(wherein Y¹s are the same or different, and are an alkyl group having 1 to 4 carbon atoms, or a halogen atom) is preferable. Specifically, examples are trimethylchlorosilane, dimethyldichlorosilane, hexamethyldisilazane, N,N-bis(trimethylsilyl)acetamide, N-trimethylsilylacetamide, N,N′-bis(trimethylsilyl)urea, N-trimethylsilyldiethylamine, N-trimethylsilylimidazole, and t-butyldimethylchlorosilane.

As the silicone oil, a silicone oil represented by the formula (6): 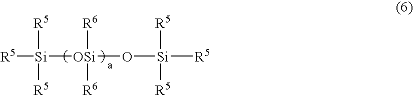
(wherein R⁵s are the same or different, and are an alkyl group having 1 to 4 carbon atoms, or a phenyl group, R⁶s are the same or different, and are a hydrogen atom, an alkyl group having 1 to 4 carbon atoms, or a phenyl group, and a is an integer of 1 to 10) is preferable. A specific example is a dimethylsilicone oil.

As the silane coupling agent, a silane coupling agent represented by the general formula (7): 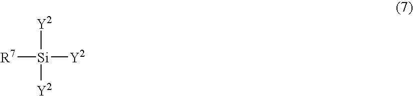
(wherein R⁷ is a vinyl group, a glycidyl group, a methacryloxy group, an amino group, a mercapto group, or an epoxy group, or may be an alkyl group having these groups, and Y²s are the same or different, and are an alkoxy group or a halogen atom) is preferable. Specific examples are vinyltrichlorosilane, vinyltris(β-methoxyethoxy)silane, vinyltriethoxysilane, vinyltrimethoxysilane, (γ-methacryloyloxypropyl)trimethoxysilane, β-(3,4-epoxycyclohexyl)ethyltrimethoxysilane, (γ-glycidyloxypropyl)trimethoxysilane, (γ-glycidyloxypropyl)methyldiethoxysilane, N-(β-aminoethyl)-γ-aminopropyltrimethoxysilane, N-(β-aminoethyl)-γ-aminopropylmethyldiethoxysilane, γ-aminopropyltriethoxysilane, N-phenyl-γ-aminopropyltrimethoxysilane, γ-mercaptopropyltrimethoxysilane, and γ-chloropropyltrimethoxysilane.

Among these, from viewpoints that an —OH group can be completely treated, and hydrophobization efficacy is high, a silylating agent and a silicone oil are preferable. Hexamethyldisilazane is more preferable since activity thereof is high, and it can be treated only by stirring without requiring a water treatment, also, hexamethyldisilazane is baked with heat at vulcanization, thus being not an outgas factor, and is relatively inexpensive.

As for a surface treatment with a silylating agent, a silicone oil, or a silane coupling agent, examples are a process in which a hydrophobic treatment agent solution is prepared by using water, alcohol (such as methanol, ethanol, and isopropanol), acetone, or toluene as a diluting solvent, thereinto a filler is immersed, and is dried by a treatment with heat at about 100 to 150° C., a process in which a filler is added while a hydrophobic treatment agent solution is sprayed or dropped and uniformly dispersed, and the filler is dried by a treatment with hear at about 100 to 150° C., and a process of reacting a hydrophobization treating solution and a filler in an autoclave (reaction temperature at 275° C., pressure of about 30 atm, heating for 1 hour). In any of these processes, a filler may be appropriately pulverized after drying.

An amount of a hydrophobic treatment agent to be added may be suitably adjusted, and it is preferable to use an amount calculated from the following equation.
Amount of a hydrophobic treatment agent (g)=weight of a filler (g)×specific surface area of a filler (m²/g)/minimum covered area of a surface treating agent (m²/g)

In addition, a concentration of a treating agent solution is not particularly limited, but is preferably 5 to 100 g/L, and more preferably 20 to 30 g/L.

A filler treated on a surface with a silylating agent or a silane coupling agent are commercially available and, among these, one having a hydrophobization degree of at least 30%, which is measured by the method described later, can be used as a filler treated on the surface by hydrophobization in the present invention.

In the present invention, it is preferable that a filler treated on the surface by hydrophobization is subsequently treated with heat under an inert gas stream. This treatment is performed in order to solve a newly riased problem that, only by treating the surface by hydrophobization, an amount of generated water can be merely reduced and, adversely, an amount of an organic outgas is increased since an organic substance derived from the treatment with an organic surface treating agent remains on the surface.

Examples of the inert gas are a nitrogen gas, a helium gas, and an argon gas, and a nitrogen gas is preferable. When this inert gas is contaminated with impurities, cleanness thereof is spoiled, thus, an inert gas specified for semiconductor is used. A flow rate is not particularly limited, but the standard of a rate is based on a degree in which a compound evaporated or decomposed into a gas due to heating does not remain around a filler.

A heating temperature and a heating time are different depending on a kind of a surface-treated filler to be heated (a kind of a filler itself and a kind of a surface treating agent), and it is preferable to heat at 100 to 300° C. for 0.5 to 4 hours, more preferable at 100 to 250° C. for 0.5 to 3 hours, further preferable at 100 to 200° C. for 0.5 to 2 hours. When a heating temperature and a heating time are in this range, an amount of an organic outgas can be considerably reduced. When a heating temperature is more than 300° C., or a heating time exceeds 4 hours, there is a tendency that a hydrophobic treatment agent is also decomposed and denatured. When a temperature is less than 100° C., or a heating time is shorter than 0.5 hour, there is a tendency that a residue of a treating agent which is to be decomposed and removed can not be decomposed.

A hydrophobization degree of a surface-treated filler measured by the method described later is at least 30%, preferably at least 45%, more preferably at least 60%, and particularly preferably at least 65%. In addition, the upper limit value is preferably at most 100%, more preferably at most 85%, and particularly preferably at most 75%. When a hydrophobization degree is less than 30%, a vulcanization rate is significantly delayed, and there is a tendency that heat resistance of a crosslinked rubber is deteriorated. When a hydrophobization degree is more than 85%, there is a tendency that particles are aggregated and, thus, a particle diameter becomes large.

Herein, the method of measuring a hydrophobization degree is explained. 0.50 g (0.50±0.01 g) of a powdery sample is weighed and added to 100 mL pure water (water temperature at 20° C.) in a 500 mL beaker, and the mixture is stirred with a magnetic stirrer. A stirrer having a diameter of 5 mmφ and a length of 4 cm is used, and stirring is performed at a rotation speed of 500 rpm. Left after stirring for 5 minutes, the powdery sample floating on the water surface is confirmed, thereafter, methanol is added to the liquid surface at a rate of 20 g per minute. A point of time, when the powdery sample is dispersed in water and no sample is recognized on the liquid surface, is regarded as the end. An amount of methanol to be added is assumed to be A, and a hydrophobization degree is measured according to the following equation.
Hydrophobization degree (%)=A/(100+A)×100

A methanol amount A corresponding to a hydrophobization degree is, for example, A=100.0 mL at a hydrophobization degree of 50%, A=150.0 mL at a hydrophobization degree of 60%, or A=233.3 mL at a hydrophobization degree of 70%. A total amount of methanol to be added until dispersing is regarded as a hydrophobization degree. It is found that the longer the amount of methanol to be added is, the greater a hydrophobization degree of a surface-treated filler is.

From a viewpoint of uniform dispersibility and the ability to form a thin film, a particle diameter of a surface-treated filler is preferably at most 5 μm, more preferably at most 1 μm, and further preferably at most 0.5 μm. The lower limit is determined by a kind of a filler.

A specific surface area of a surface-treated filler is preferably 50 to 300 m²/g, and more preferably 100 to 300 m²/g. When a specific surface area is less than 50 m²/g, there is a tendency that particle contamination due to a filler is caused when a rubber is etched by a plasma in a semiconductor manufacturing equipment and, when a specific surface area exceeds 300 m²/g, there is a tendency that workability at roll kneading is deteriorated.

An amount of a filler to be added is preferably 5 to 30 parts by weight, and more preferably 5 to 15 parts by weight based on 100 parts by weight of a fluorine-containing elastomer. When an amount of a filler is less than 5 parts by weight, there is a tendency that the shielding effect against a plasma is low, and when an amount of a filler is increased, plasma resistance is improved. When the amount is more than 30 parts by weight, there is a tendency that rubber elasticity of a molded article is reduced, and sealing property is remarkably lowered.

A crosslinking agent used in the present invention is at least one kind of a crosslinking agent selected from the group consisting of an oxazole crosslinking agent, an imidazole crosslinking agent, a thiazole crosslinking agent, and a triazine crosslinking agent and, among these, an imidazole crosslinking agent is more preferable from viewpoints of obtaining a crosslinked product excellent in mechanical strength, heat resistance, chemical resistance, and cold resistance, and particularly having a excellent balance between heat resistance and cold resistance.

From a viewpoint of heat resistance, it is preferable that the oxazole crosslinking agent, the imidazole crosslinking agent, the thiazole crosslinking agent, or the triazine crosslinking agent is at least one compound selected from the group consisting of a compound containing at least two crosslinkable reactive groups represented by the general formula (1): 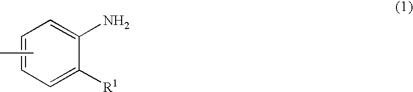
(wherein R¹ is the same or different, and is —NH₂, —NHR², —OH or —SH, and R² is a fluorine atom or a monovalent organic group), a compound represented by the general formula (2): 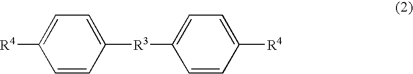
(wherein R³ is —SO₂—, —O—, —CO—, an alkylene group having 1 to 6 carbon atoms, a perfluoroalkylene group having 1 to 10 carbon atoms, or a single bond, and R⁴ is 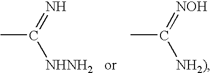
a compound represented by the general formula (3): 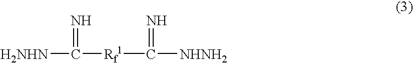
(wherein R_{f}¹ is a perfluoroalkylene group having 1 to 10 carbon atoms), and a compound represented by the general formula (4): 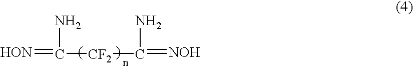
(wherein n is a integer of 1 to 10).

Among these, from a viewpoint that heat resistance is improved since a form after crosslinking is stabilized by an aromatic ring, a compound having at least two crosslinkable reactive groups represented by the general formula (1) is preferable.

The compound having at least two crosslinkable reactive groups represented by the general formula (1) has preferably 2 to 3 crosslinkable reactive groups represented by the general formula (1), and more preferably 2 of them. When the number of crosslinkable reactive groups represented by the general formula (1) is less than 2, crosslinking is impossible.

A substituent R² in the crosslinkable reactive group represented by the general formula (1) is a monovalent organic group other than a hydrogen atom, or a fluorine atom. Since a N—R² bond has higher oxidation resistance than a N—H bond, a N—R² bond is preferable.

The monovalent organic group is not particularly limited, but examples are an aliphatic hydrocarbon group, a phenyl group, and a benzyl group. Specifically, examples are a lower alkyl group having 1 to 10 carbon atoms, particularly 1 to 6 carbon atoms in which at least one of R²s is —CH₃, —C₂H₅, or —C₃H₇; a fluorine atom-containing lower alkyl group having 1 to 10 carbon atoms, particularly 1 to 6 carbon atoms such as —CF₃, —C₂F₅, —CH₂F, —CH₂CF₃, and —CH₂C₂F₅; a phenyl group; a benzyl group; a phenyl group or a benzyl group in which 1 to 5 hydrogen atoms are substituted with a fluorine atom, for example, —C₆F₅ or —CH₂C₆F₅; a phenyl group or a benzyl group in which 1 to 5 hydrogen atoms are substituted with —CF₃, for example, —C₆H₅₋ₙ(CF₃)ₙ or —CH₂C₆H₅₋ₙ(CF₃)ₙ (n is an integer of 1 to 5).

Among these, from viewpoints that heat resistance is particularly excellent, crosslinking reactivity is good and, further, synthesis is relatively easy, a phenyl group and —CH₃ are preferable.

As the crosslinking agent, from a viewpoint of easiness in synthesis, a compound having two crosslinkable reactive groups represented by the general formula (1) which is represented by the general formula (8): 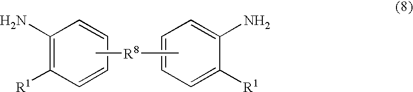
(wherein R¹s are the same as descried above, and R⁸ is —SO₂—, —O—, —CO—, an alkylene group having 1 to 6 carbon atoms, a perfluoroalkylene group having 1 to 10 carbon atoms, a single bond, or 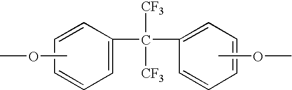
) is preferable.

Preferable examples of an alkylene group having 1 to 6 carbon atoms are a methylene group, an ethylene group, a propylene group, a butylene group, a pentylene group, and a hexylene group, and an example of a perfluoroalkylene group having 1 to 10 carbon atoms is

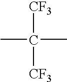

These compounds are known as the examples of bisdiaminophenyl compounds in JP-B-2-59177 and JP-A-8-120146.

Among these, a more preferable compound (A) is a compound represented by the general formula (9): 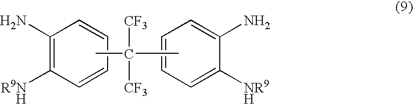
(wherein R⁹s are the same or different, and are a hydrogen atom, or an alkyl group having 1 to 10 carbon atoms; a fluorine atom-containing alkyl group having 1 to 10 carbon atoms; a phenyl group; a benzyl group; a phenyl group or a benzyl group in which 1 to 5 hydrogen atoms are substituted with a fluorine atom and/or —CF₃).

Although not limited to there, but specific examples are 2,2-bis(3,4-diaminophenyl)hexafluoropropane, 2,2-bis[3-amino-4-(N-methylamino)phenyl]hexafluoropropane, 2,2-bis[3-amino-4-(N-ethylamino)phenyl]hexafluoropropane, 2,2-bis[3-amino-4-(N-propylamino)phenyl]hexafluoropropane, 2,2-bis[3-amino-4-(N-phenylamino)phenyl]hexafluoropropane, 2,2-bis[3-amino-4-(N-perfluorophenylamino)phenyl]hexafluoropropane, and 2,2-bis[3-amino-4-(N-benzylamino)phenyl]hexafluoropropane. Among these, from viewpoints that heat resistance is excellent, and crosslinking reactivity is particularly excellent, 2,2-bis(3,4-diaminophenyl)hexafluoropropane is further preferable.

Such a bisamidoxime crosslinking agent, a bisamidrazone crosslinking agent, a bisaminophenol crosslinking agent, a bisaminothiophenol crosslinking agent and a bisdiaminophenyl crosslinking agent react with a cyano group, a carboxyl group and an alkoxycarbonyl group contained in a fluorine-containing elastomer to form an oxazole ring, a thiazole ring, an imidazole ring or a triazine ring to give a crosslinked product.

An amount of a crosslinking agent to be added is preferably 0.1 to 20 parts by weight, and more preferably 0.5 to 10 parts by weight based on 100 parts by weight of a fluorine-containing elastomer. When the amount of the crosslinking agent is less than 0.1 part by weight, there is a tendency that practically sufficient mechanical strength, heat resistance and chemical resistance are not obtained and, when the amount is more than 20 parts by weight, there is a tendency that, besides it takes a long time to crosslink, a crosslinked product is hard and loses flexibility.

A fluorine-containing elastomer used in the present invention is not particularly limited as long as it has a crosslinking site capable of a crosslinking reaction with the crosslinking agent.

Preferable examples of a crosslinking site capable of a crosslinking reaction with a crosslinking agent are a cyano group (—CN group), a carboxyl group (—COOH group), or an alkoxycarbonyl group (—COOR¹⁰ group, R¹⁰ is an alkyl group having 1 to 3 carbon atoms) from a viewpoint that heat resistance can be imparted to a molded article and these sites can form an oxazole ring, a thiazole ring, or an imidazole ring with a crosslinking agent, as described above. Among these, from a viewpoint of crosslinking reactivity, a cyano group is more preferable. In addition, from a viewpoint of easiness in the preparation, a carboxyl group and an alkoxycarbonyl group are more preferable, and a carboxyl group is particularly preferable.

Examples of a fluorine-containing elastomer are a non-perfluoro fluorine rubber and a perfluoro fluorine rubber.

Examples of the non-perfluoro fluorine rubber are a vinylidene fluoride (VdF) fluorine rubber, a tetrafluoroethylene (TFE)/propylene fluorine rubber, a tetrafluoroethylene (TFE)/propylene/vinylidene fluoride (VdF) fluorine rubber, an ethylene/hexafluoroethylene (HFP) fluorine rubber, an ethylene/hexafluoropropylene (HFP)/vinylidene fluoride (VdF) fluorine rubber, an ethylene/hexafluoropropylene (HFP)/tetrafluoroethylene (TFE) fluorine rubber, a fluorosilicone fluorine rubber, and a fluorophosphazene fluorine rubber, and these may be used alone, or by arbitrarily combining them in a range where the effects of the present invention are not deteriorated.

The vinylidene fluoride fluorine rubber refers to a fluorine-containing copolymer comprising 45 to 85% by mole of vinylidene fluoride, and 55 to 15% by mole of at least one kind of other monomer which is copolymerizable with vinylidene fluoride. Preferably, the vinylidene fluoride fluorine rubber refers to a fluorine-containing copolymer comprising 50 to 80% by mole of vinylidene fluoride, and 50 to 20% by mole of at least one kind of other monomer which is copolymerizable with vinylidene fluoride.

Examples of at least one kind of other monomer which is copolymerizable with vinylidene fluoride are fluorine-containing monomers such as tetrafluoroethylene (TFE), chlorotrifluoroethylene (CTFE), trifluoroethylene, hexafluoropropylene (HFP), trifluoropropylene, tetrafluoropropylene, pentafluoropropylene, trifluorobutene, tetrafluoroisobutene, perfluoro(alkyl vinyl ether) (PAVE), and vinyl fluoride, and non-fluorine monomers such as ethylene, propylene, and alkyl vinyl ether. These can be used alone, or by arbitrarily combining them. Among these, tetrafluoroethylene, hexafluoropropylene, and perfluoro(alkyl vinyl ether) are preferable.

Specific examples of the rubber are a VdF-HFP rubber, a VdF-HFP-TFE rubber, a VdF-CTFE rubber, and a VdF-CTFE-TFE rubber.

The tetrafluoroethylene/propylene fluorine rubber refers to a fluorine-containing copolymer comprising 45 to 70% by mole of tetrafluoroethylene and 55 to 30% by mole of propylene and, further, containing 0 to 5% by mole of a monomer giving a crosslinking site based on the total amount of tetrafluoroethylene and propylene.

Examples of the monomer giving a crosslinking site are iodine-containing monomers such as perfluoro(6,6-dihydro-6-iodo-3-oxa-1-hexene) and perfluoro(5-iodo-3-oxa-1-pentene) described in JP-B-5-63482 and JP-A-7-316234, bromine-containing monomers described in JP-A-4-505341, and cyano group-containing monomers, carboxyl group-containing monomers, and alkoxycarbonyl group-containing monomers described in JP-A-4-505345 and JP-A-5-500070.

These non-perfluoro fluorine rubbers can be prepared by conventional processes.

An example of the perfluoro fluorine rubber is a rubber comprising a tetrafluoroethylene/perfluoro(alkyl vinyl ether)/monomer giving crosslinking site. A composition of tetrafluoroethylene/perfluoro(alkyl vinyl ether) is preferably 50 to 90/10 to 50% by mole, more preferably 50 to 80/20 to 50% by mole, further preferably 55 to 70/30 to 45% by mole. In addition, the monomer giving a crosslinking site is preferably 0 to 5% by mole, more preferably 0 to 2% by mole based on the total amount of teterafluoroethylene and perfluoro(alkyl vinyl ether). When the composition is out of these ranges, there are tendencies that properties as a rubber elastic body is lost and the properties become closer to those of resin.

Examples of perfluoro(alkyl vinyl ether) in this case are perfluoro(methyl vinyl ether) and perfluoro(propyl vinyl ether), and these can be used alone or by arbitrarily combining them.

Examples of the monomer giving a crosslinking site are an iodine-containing monomer or a bromine-containing monomer represented by the general formula (10):
CY³₂═CY³R_{f}²CHR¹¹—X¹ (10)
(wherein Y³ is a hydrogen atom, a fluorine atom or —CH₃, R_{f}² is a linear or branched a fluoro or perfluoroalkylene group which may have at least one ether-type oxygen atom, or a fluoro or perfluorooxyalkylene group, or a perfluoropolyoxyalkylene group, R¹¹ is a hydrogen atom or a methyl group, and X¹ is an iodine atom or a bromine atom), monomers represented by the general formulas (11) to (27):
CY⁴₂═CY⁴(CF₂)ₙ—X² (11)
(wherein Y⁴ is a hydrogen atom or a fluorine atom, and n is an integer of 1 to 8),
CF₂═CFCF₂R_{f}³—X² (12)
(wherein R_{f}³ is 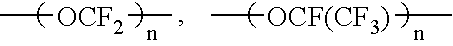
and n is an integer of 0 to 5),
CF₂═CFCF₂ (OCF(CF₃)CF₂)ₘ(OCH₂CF₂CF₂)ₙOCH₂CF₂—X² (13)
(wherein m is an integer of 0 to 5, and n is an integer of 0 to 5),
CF₂═CFCF₂ (OCH₂CF₂CF₂)ₘ(OCF(CF₃)CF₂)ₙOCF(CF₃)—X² (14)
(wherein m is an integer of 0 to 5, and n is an integer of 0 to 5),
CF₂═CF(OCF₂CF(CF₃))ₘO(CF₂)ₙ—X² (15)
(wherein m is an integer of 0 to 5, and n is an integer of 1 to 8),
CF₂═CF(OCF₂CF(CF₃))ₘ—X² (16)
(wherein m is an integer of 1 to 5),
CF₂═CFOCF₂(CF(CF₃)OCF₂)ₙCF(—X²)CF₃ (17)
(wherein n is an integer of 1 to 4),
CF₂═CFO(CF₂)ₙOCF(CF₃)—X² (18)
(wherein n is an integer of 2 to 5),
CF₂═CFO(CF₂)ₙ—(C₆H₄)—X² (19)
(wherein n is an integer of 1 to 6),
CF₂═CF(OCF₂CF(CF₃))ₙOCF₂CF(CF₃)—X² (20)
(wherein n is an integer of 1 to 2),
CH₂═CFCF₂O(CF(CF₃)CF₂O)ₙCF(CF₃)—X² (21)
(wherein n is an integer of 0 to 5),
CF₂═CFO(CF₂CF(CF₃)O)ₘ(CF₂)ₙ—X² (22)
(wherein m is an integer of 0 to 5, and n is an integer of 1 to 3),
CH₂═CFCF₂OCF(CF₃)OCF(CF₃)—X² (23)
CH₂═CFCF₂OCH₂CF₂—X² (24)
CF₂═CFO(CF₂CF(CF₃)O)ₘCF₂CF(CF₃) —X² (25)
(wherein m is an integer of 0 or more),
CF₂═CFOCF(CF₃)CF₂O(CF₂)ₙ—X² (26)
(wherein n is an integer of at least 1),
CF₂═CFOCF₂OCF₂CF(CF₃)OCF₂—X² (27)
(in the general formulas (11) to (27), X² is a cyano group (—CN group), a carboxyl group (—COOH group) or an alkoxycarbonyl group (—COOR¹⁰ group, R¹⁰ is an alkyl group which may contain a fluorine atom having 1 to 10 carbon atoms)), and
an iodine-containing monomer or a bromine-containing monomer represented by the general formula (28):
CH₂═CH—(CF₂)ₙX³ (28)
(wherein n is an integer of 2 to 8, and X³ is an iodine atom or a bromine atom),
and these can be used alone or by arbitrarily combining them.

As the iodine- or bromine-containing monomer represented by the general formula (10), an iodine-containing fluorinated vinyl ether represented by the general formula (29): 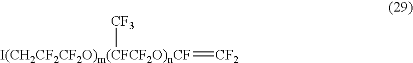
(wherein m is an integer of 1 to 5, and n is an integer of 0 to 3) is preferably exemplified, and more specifically, examples are:

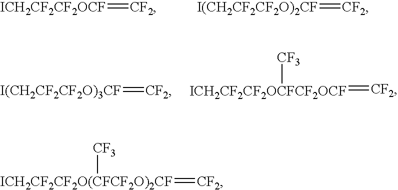

Among these, ICH₂CF₂CF₂OCF═CF₂ is preferable.

A more specific example of an iodine-containing monomer or a bromine-containing monomer represented by the general formula (28) is preferably CH₂═CHCF₂CF₂I.

In monomers represented by the general formulas (11) to (27), the cyano group, the carboxyl group or the alkoxycarbonyl group thereof is crosslinking site, and crosslinking reaction progresses.

Further, when an iodine-containing monomer or a bromine-containing monomer represented by the general formula (10), (27) or (29) is used, peroxide crosslinking may progress in addition to the above-mentioned crosslinking reaction.

These perfluoro fluorine rubbers can be prepared by conventional processes.

Specific examples of the perfluoro fluorine rubbers are fluorine rubbers described in WO97/24381, JP-B-61-57324, JP-B-4-81608, and JP-B-5-13961.

As a fluorine-containing elastomer, a thermoplastic fluorine rubber comprising an elastomeric fluorine-containing polymer chain segment and a non-elastomeric fluorine-containing polymer chain segment may be used, and a rubber composition comprising the above-mentioned fluorine rubber and a thermoplastic fluorine rubber may be used.

As a process of isolating a polymerization product from a polymerization reaction mixture, a process of coagulation by an acid treatment is preferable from a viewpoint of simplification of its steps. Also, a polymerization mixture is treated with an acid and, thereafter, a polymerization product may be isolated by a means such as freeze dry.

Further, a process of coagulation with the ultrasound or coagulation with mechanical force may be adopted.

In a fluorine-containing elastomer used in the present invention, a group such as a metal salt or an ammonium salt of carboxylic acid present in a polymerization product can be converted into a carboxyl group by treating a polymerization product with an acid. As the method for treatment with acid, the method of washing with hydrochloric acid, sulfuric acid or nitric acid, or adjusting the pH of the system of mixture after a polymerization reaction to at most pH3 with these acids is suitable.

A carboxyl group can be introduced by oxidizing a crosslinkable elastomer containing iodine or bromine by fuming nitric acid.

Further, as a method of introducing a cyano group, a carboxyl group or an alkoxycarbonyl group, a method described in WO00/05959 can be used.

In the present invention, in the field in which high purity and non-contaminating properties are not particularly required, when necessary, conventional additives which are compounded into a fluorine-containing elastomer composition such as a filler, a processing aid, a plasticizer, a coloring agent, a stabilizer and an adhesion aid can be compounded, and at least one kind of a conventional crosslinking agent and a crosslinking aid which are different from those as described above may be compounded.

Also, the present invention relates to a process for preparing a fluorine-containing elastomer composition comprising a step of preparing a surface-treated filler by treating a surface of a filler with a hydrophobic treatment agent so as to have a hydrophobization degree of at least 30% measured by the following method, and a step of mixing the surface-treated filler, at least one kind of a crosslinking agent selected from the group consisting of an oxazole crosslinking agent, an imidazole crosslinking agent, a thiazole crosslinking agent and a triazine crosslinking agent, and a fluorine-containing elastomer having a crosslinking site capable of a crosslinking reaction with the crosslinking agent.

As a process for preparing the surface-treated filler, the above-described process can be favorably used.

In addition, as for the a step of mixing the surface-treated filler, at least one kind of a crosslinking agent selected from the group consisting of an oxazole crosslinking agent, an imidazole crosslinking agent, a thiazole crosslinking agent and a triazine crosslinking agent, and a fluorine-containing elastomer having a crosslinking site capable of a crosslinking reaction with the crosslinking agent, a mixture can be prepared by mixing those components by using a conventional processing machine for an elastomer such as an open roll, a Banbury mixer and a kneader. Besides these, a mixture can be prepared also by the method of using an internal mixer.

A method of obtaining a pre-molded article from the above-described compositions may be a conventional method, and can be performed by the known methods such as a method of heat compressing in a metal mold, a method of injecting into a heated metal mold, and a method of extruding with an extruder. In the case of an extruded product such as a hose and an electric wire, a crosslinked molded article can be obtained by heat crosslinking with steam after extrusion.

The conditions for crosslinking in the present invention are not particularly limited, but crosslinking can be carried out under the conventional crosslinking conditions for a fluorine-containing elastomer. For example, when oxazole crosslinking is performed, a mixture is placed into a metal mold, press-crosslinked by holding at 120 to 250° C. for 1 to 60 minutes under pressure and, subsequently, oven-crosslinked by holding in an oven of 120 to 320° C. for 0 to 48 hours, thereby, a crosslinked product can be obtained. Combination crosslinking may be also carried out by adding bis(aminophenol) AF to compositions for the known processes of crosslinking an elastomer such as polyamine crosslinking, polyol crosslinking, and peroxide crosslinking.

When imidazole crosslinking is conducted, this crosslinking is suitable for a carboxyl-containing polymer having a carboxyl group at a position other than the terminal, which gives a crosslinked product having excellent physical properties at a relatively low crosslinking temperature (for example, 150 to 230° C., preferably 170 to 200° C.).

By molding the fluorine-containing elastomer composition of the present invention by crosslinking, a molded article of the present invention can be obtained. The molded article of the present invention is excellent in a compression set.

Further, an elastomeric molded article is coated with a coating material using the fluorine-containing elastomer composition of the present invention and crosslinked thereof, thereby, a coated molded article can be obtained.

As an elastomeric molded article to be coated, articles prepared with various elastomeric materials can be used, but particularly, from a viewpoint of heat resistance, it is preferable to use a fluorine-containing elastomer or a silicone elastomer.

The molded article and the coated molded article of the present invention are useful as various molded articles in a variety of fields as shown in the following.

In the related fields of semiconductor including semiconductor manufacturing equipment, liquid crystal panel manufacturing apparatuses, plasma panel manufacturing apparatuses, plasma addressed liquid crystal panels, field-emission display panels, and solar cell boards, O(square)-rings, packing, sealing materials, tubes, rolls, coating, lining, gaskets, diaphragms, hoses, and the like are cited. And they can be used in CVD apparatuses, dry etching apparatuses, wet etching apparatuses, oxidation diffusion apparatuses, sputtering apparatuses, ashing apparatus, cleaning equipment, ion implantation systems, exhaust systems, liquid medicine piping, and gas piping. Specifically, they can be used as O-rings and sealing materials for gate valves, as O-rings and sealing materials for quartz windows, as O-rings and sealing materials for chambers, as O-rings and sealing materials for gates, as O-rings and sealing materials for bell jars, as O-ring and sealing materials for couplings, as O-rings, sealing materials and diaphragms for pumps, as O-ring and sealing materials for gas controllers for semiconductors, as O-rings and sealing materials for resist developers and resist strippers, as hoses and tubes for wafer cleaning solution, as rolls for conveying wafer, as lining and coating for resist developer baths and resist stripper baths, as lining and coating for wafer cleaning solution baths, or as lining and coating for wet etching baths. Further, they are used for sealants and sealing agents, for covering materials of quartz in optical fibers, for potting, coating, and adhesive seals in electronic components and breadboards that have the purposes of electrical insulation, vibration control, waterproofing, and moistureproofing, for gaskets for magnetic storages, for modifying agents of sealants such as epoxy resins, for sealants for clean rooms and clean equipment, and the like.

Further, they can be widely used in the fields such as the automobile field, the aircraft field, the rocket field, the marine vessel field, the field of chemical products such as plants, the field of medicals such as pharmaceuticals, the photograph field such as developing machines, the printing field such as printing machines, the painting field such as painting equipment, analyzer and physical and chemical equipment field, the field of equipment in food factories, the field of equipment in atomic power plants, the field of iron and steel such as iron plate processing equipment, the field of general industry, the field of electricity, the field of fuel cells, the field of electronic parts, and the field of molded products that can be formed on-site.

### EXAMPLES

Hereinafter, the present invention is explained based on Examples, however, the present invention is not limited thereto.

Evaluation Method

<Compression Set>

A compression set of an O-ring (AS-568A-214) after 72 hours and 168 hours at 300° C. and 275° C. is measured according to JIS K6301.

(Standard Vulcanization Conditions)

Kneading method: Roll kneading
Press vulcanization: 30 minutes at 180° C.
Oven vulcanization: 18 hours at 290° C.
   <100% modulus (M100)>

A curable composition shown in Table 1 is formed into a sheet having a thickness of 2 mm by primary press vulcanization and secondary oven vulcanization under the standard vulcanization conditions, and 100% modulus thereof is measured according to JIS-K6251.

<Tensile Strength at Break (Tb) and Elongation at Break (Eb)>

A curable composition shown in Table 1 is formed into a sheet having a thickness of 2 mm by primary press vulcanization and secondary oven vulcanization under the standard vulcanization conditions, and tensile strength at break (Tb) and elongation at break (Eb) thereof are measured according to JIS-K6251.

<Vulcanization Properties>

A vulcanization curve at 180° C. is found in primary press vulcanization by using a JSR-type curastometer model II, and minimum viscosity (ML), the vulcanization degree (MH), the induction time (T10) and the optimum vulcanization time (T90) are found.

<Shore A Hardness>

Shore A hardness is measured according to ASTM D2240. Specifically, the measurement is carried out with an analog hardness meter A-type manufactured by KOUBUNSHI KEIKI CO., LTD.

<Method of Measuring Hydrophobization Degree>

0.50 g (0.50±0.01 g) of a powdery sample is weighed and added to 100 mL pure water (water temperature at 20° C.) in a 500 mL beaker, and the mixture is stirred with a magnetic stirrer (Mighty Magnetic Stirrer HE-20 GA manufactured by KPI). A stirrer having a diameter of 5 mmφ and a length of 4 cm is used, and stirring is conducted at a rotation speed of 500 rpm. Left after stirring for 5 minutes, the powdery sample floating on the water surface is confirmed, thereafter, methanol is added to the liquid surface at a rate of 20 g per minute. A point of time when the powdery sample is dispersed in water and no sample is recognized on the liquid surface is regarded as the end. An amount of methanol to be added is assumed to be A, and a hydrophobization degree is measured according to the following equation.
Hydrophobization degree (%)=A/(100+A)×100

As a measurement example, a hydrophobization degree of fumed silica (RX200 available from NIPPON AEROSIL CO., LTD.; an average particle diameter of 12 nm, a specific surface area of 140 m²/g) subjected to a hydrophobization treatment by using hexamethyldisilazane, which is a silylating agent, was 69%.

### Preparation Example 1

A 6-liter stainless steel autoclave without an ignition source was charged with 2.3 liter of pure water, 23 g of 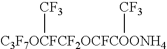
as an emulsifier, and 0.2 g of ammonium carbonate as a pH adjuster. After system was sufficiently replaced with a nitrogen gas to deaerate the system, a temperature was raised to 50° C. while stirring at 600 rpm, and tetrafluoroethylene (TFE) and perfluoro(methyl vinyl ether) (PMVE) were charged thereto at TFE/PMVE=24/76 (molar ratio) to become an inside pressure of 0.8 MPa. Then, 0.8 g of CF₂═CFOCF₂CF(CF₃)OCF₂CF₂CN(CNVE) was injected by nitrogen pressure. 10 mL of an aqueous solution of ammonium persulfate (APS) having a concentration of 1.2 g/mL was injected by nitrogen pressure and a reaction was initiated.

12 g of TFE and 13 g of PMVE were respectively injected by their own pressure at the time when an inside pressure was lowered to 0.7 MPa with progression of polymerization. Thereafter, as the reaction progressed, TFE and PMVE were injected in the same manner, and increase and decrease in pressure were repeated between 0.7 to 0.9 MPa, at the same time, 0.9 g of CNVE was injected by nitrogen pressure every 80 g of an addition amount of TFE and PMVE.

When the total charging amount of TFE and PMVE reached 680 g, the autoclave was cooled and unreacted monomers were discharged to obtain 3110 g of an aqueous dispersion having solid content concentration of 22% by weight.

3110 g of the aqueous dispersion was diluted with 3730 g of water, and slowly added while stirring to 3450 g of a nitric acid solution having a concentration of 4.8% by weight. After the solution was stirred for 30 minutes after adding, coagulated substances were filtered, and the obtained polymer was washed with water and then dried with vacuum to obtain 680 g of a polymer.

As a result of ¹⁹F-NMR analysis, the monomer unit composition of this polymer was found to be TFE/PMVE/CNVE=60.0/39.5/0.5 (% by mole). When the polymer was measured by an infrared spectroscopic analysis, characteristic absorption of a carboxyl group was recognized at around 1774.9 cm₋₁ and 1808.6 cm₋₁, and characteristic absorption of an OH group was recognized at around 3557.5 cm₋₁ and 3095.2 cm₋₁.

### Example 1

The cyano group-containing fluorine-containing elastomer having a carboxyl group at the terminal obtained in Preparation Example 1,

2,2-bis[3-amino-4-(N-phenylamino)phenyl]hexafluoropropane (AFTA-Ph) which is a crosslinking agent synthesized by the process described in Journal of Polymer Science, Polymer Chemistry edition, Vol. 20, pages 2381 to 2393 (1982), and fumed silica (RX200 available from NIPPON AEROSIL CO., LTD.; average particle diameter of 12 nm, specific surface area of 140 m²/g) subjected to a hydrophobization treatment by using hexamethyldisilazane, which is a silylating agent, as a filler were mixed at a weight ratio of 100/1.2/10, and kneaded with an open roll to prepare a crosslinkable fluorine-containing elastomer composition.

This elastomer composition was press-crosslinked (primary crosslinking) at 180° C. for a period of time corresponding to T90 and, then, oven-crosslinked (secondary crosslinking) at 290° C. for 18 hours to prepare an O-ring (AS-568A-214). In addition, a vulcanization curve of the composition, at 180° C. was found by using a JSR-type curastomer model II (manufactured by JSR Trading Co., Ltd.), and the minimum viscosity (ML), the vulcanization degree (MH), the induction time (T10) and the optimum vulcanization time (T90) were found. Further, the compression set (275° C. and 300° C., 72 hours, 25% compression) was measured. Results thereof are shown in Table 1.

### Example 2

A fluorine-containing elastomer composition was prepared in the same manner as Example 1, except for blending fumed silica treated on the surface with a silicone oil (RY200 available from NIPPON AEROSIL CO., LTD., an average particle diameter of 12 nm, a specific surface area of 100 m²/g) in place of fumed silica treated on the surface with hexamethylsilazane in Example 1 and, further, the composition was molded into an O-ring in the same manner as Example 1. Various properties of the composition and the molded article were measured in the same manner as Example 1, and results thereof are shown in Table 1.

### Example 3

A fluorine-containing elastomer composition was prepared in the same manner as Example 1, except for blending fumed silica treated on the surface with a silane coupling agent (RA200H available from NIPPON AEROSIL CO., LTD., an average particle diameter of 12 nm, a specific surface area of 140 m²/g) in place of fumed silica treated on the surface with hexamethylsilazane in Example 1 and, further, the composition was molded into an O-ring in the same manner as Example 1. Various properties of the composition and the molded article were measured in the same manner as Example 1, and results thereof are shown in Table 1.

### Example 4

A fluorine-containing elastomer composition was prepared in the same manner as Example 1, except for blending fumed silica having a larger particle diameter, which is hydrophobicized by chemically covering the surface with a CH₃ group (R972V available from NIPPON AEROSIL CO., LTD., an average particle diameter of 16 nm, a specific surface area of 110 m²/g) in place of fumed silica treated on the surface with hexamethylsilazane in Example 1 and, further, the composition was molded into an O-ring in the same manner as Example 1. Various properties of the composition and the molded article were measured in the same manner as Example 1, and results thereof are shown in Table 1.

### Comparative Example 1

A fluorine-containing elastomer composition was prepared in the same manner as Example 1, except for blending fine particles of fumed silica having a large number of hydroxy groups on the surface (200V available from NIPPON AEROSIL CO., LTD., an average particle diameter of 12 nm, a specific surface area of 200 m²/g) in Example 1 and, further, the composition was molded into an O-ring in the same manner as Example 1. Various properties of the composition and the molded article were measured in the same manner as Example 1, and results thereof are shown in Table 1.

### Comparative Example 2

A fluorine-containing elastomer composition was prepared in the same manner as Example 1, except for blending fine particles of fumed silica having a large number of hydroxy groups on the surface (Cab-O-Sil M-7D available from Cabbot Specialty Chemicals Ink., a particle diameter of 12 nm, a specific surface area of 200 m²/g) in Example 1 and, further, the composition was molded into an O-ring in the same manner as Example 1. Various properties of the composition and the molded article were measured in the same manner as Example 1, and results thereof are shown in Table 1.

### Comparative Example 3

A fluorine-containing elastomer composition was prepared in the same manner as Example 1, except for blending fine particles of fumed silica having a large number of hydroxy groups on the surface (130 available from NIPPON AEROSIL CO., LTD., an average particle diameter of 16 nm, a specific surface area of 130 m²/g) in Example 1 and, further, the composition was molded into an O-ring in the same manner as Example 1. Various properties of the composition and the molded article were measured in the same manner as Example 1, and results thereof are shown in Table 1.

TABLE 1

| | | Ex. | | | | Com. Ex. | | |
|---|---|---|---|---|---|---|---|---|
| | Unit | 1 | 2 | 3 | 4 | 1 | 2 | 3 |
| Crosslinking elastomer | part | 100 | 100 | 100 | 100 | 100 | 100 | 100 |
| Crosslinking agent | part | 1.2 | 1.2 | 1.2 | 1.2 | 1.2 | 1.2 | 1.2 |
| Silicon oxide fine particles | part | 10 | 10 | 10 | 10 | 10 | 10 | 10 |
| Silicon oxide | | | | | | | | |
| Average particle diameter | nm | 12 | 12 | 12 | 16 | 12 | 12 | 16 |
| Hydrophobization degree | % | 69 | 68 | 38 | 50 | 0 | 0 | 0 |
| 100% modulus | kgf | 25 | 34 | 40 | 30 | 30 | 51 | 47 |
| Tensile strength at break | kgf | 187 | 165 | 184 | 140 | 171 | 176 | 211 |
| Tensile elongation at break | % | 293 | 304 | 270 | 277 | 286 | 290 | 271 |
| Hardness (Shore A) peak value | | 71 | 75 | 74 | 72 | 78 | 74 | 75 |
| Curasto model II (170° C.) | | | | | | | | |
| Minimum viscosity (ML) | Kgf | 0.67 | 0.56 | 1.37 | 0.88 | 0.91 | 1.25 | 0.82 |
| Vulcanization degree (MH) | Kgf | 3.18 | 2.95 | 3.20 | 3.48 | 2.70 | 2.70 | 3.00 |
| Induction time (T10) | min. | 7.0 | 6.4 | 1.0 | 6.9 | 16.0 | 15.0 | 14.0 |
| Optimal vulcanization time (T90) | min. | 16.5 | 17.0 | 7.2 | 15.0 | 120.0 | 140.0 | 60.0 |
| Compression set | % | 24 | 32 | 47 | 32 | 66 | 65 | 47 |
| (275° C. × 72 hr) | | | | | | | | |
| Compression set | % | 16 | 20 | 34 | 23 | 48 | 54 | 38 |
| (300° C. × 72 hr) | | | | | | | | |

The present invention can provide a molded article having small compression set due to adopting a fluorine-containing elastomer composition containing a filler having a hydrophobization degree of at least 30% which is measured by a particular method.

What is claimed is:

1. A fluorine-containing elastomer composition comprising at least one kind of a crosslinking agent selected from the group consisting of an oxazole crosslinking agent, an imidazole crosslinking agent, a thiazole crosslinking agent and a triazine crosslinking agent, a fluorine-containing elastomer having a crosslinking site capable of a crosslinking reaction with the crosslinking agent, and a surface-treated filler, wherein a hydrophobization degree of the surface-treated filler is at least 30% which is measured by the following method.
Note
<Method of Measuring Hydrophobization Degree>
0.50 g (0.50±0.01 g) of a powdery sample is weighed and added to 100 mL pure water (water temperature at 20° C.) in a 500 mL beaker, and the mixture is stirred with a magnetic stirrer. A stirrer having a diameter of 5 mmφ and a length of 4 cm is used, and stirring is performed at a rotation speed of 500 rpm. Left after stirring for 5 minutes, the powdery sample floating on the water surface is confirmed, thereafter, methanol is added to the liquid surface at a rate of 20 g per minute. A point of time, when the powdery sample is dispersed in water and no sample is recognized on the liquid surface, is regarded as the end. An amount of methanol to be added is assumed to be A, and a hydrophobization degree is measured according to the following equation.
Hydrophobization degree (%)=A/(100+A)×100

2. The fluorine-containing elastomer composition of claim 1, wherein the crosslinking agent is at least one compound selected from the group consisting of a compound containing at least two crosslinkable reactive groups represented by the general formula (1): 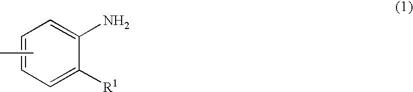
(wherein R¹ is the same or different, and is —NH₂, —NHR², —OH or —SH, and R² is a fluorine atom or a monovalent organic group), a compound represented by the general formula (2): 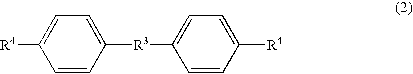
(wherein R³ is —SO₂—, —O—, —CO—, an alkylene group having 1 to 6 carbon atoms, a perfluoroalkylene group having 1 to 10 carbon atoms, or a single bond, and R⁴ is 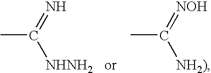
a compound represented by the general formula (3): 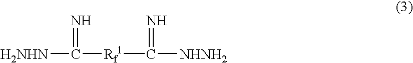
(wherein R_{f}¹ is a perfluoroalkylene group having 1 to 10 carbon atoms), and a compound represented by the general formula (4): 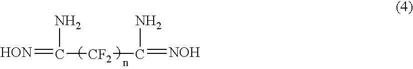
(wherein n is an integer of 1 to 10).

3. The fluorine-containing elastomer composition of claim 1, wherein the fluorine-containing elastomer has at least one group selected from the group consisting of a cyano group, a carboxyl group and an alkoxycarbonyl group.

4. The fluorine-containing elastomer composition of claim 1, wherein the filler is an inorganic filler.

5. The fluorine-containing elastomer composition of claim 1, wherein the filler is anhydrous silica.

6. A molded article, which is obtained by crosslinking the fluorine-containing elastomer composition of claim 1.

7. A process for preparing a fluorine-containing elastomer composition comprising a step of preparing a surface-treated filler by treating a surface of a filler with a hydrophobic treatment agent so as to have a hydrophobization degree of at least 30% measured by the following method, and a step of mixing the surface-treated filler, at least one kind of a crosslinking agent selected from the group consisting of an oxazole crosslinking agent, an imidazole crosslinking agent, a thiazole crosslinking agent and a triazine crosslinking agent, and a fluorine-containing elastomer having a crosslinking site capable of a crosslinking reaction with the crosslinking agent.
Note
<Method of Measuring Hydrophobization Degree>
0.50 g (0.50±0.01 g) of a powdery sample is weighed and added to 100 mL pure water (water temperature at 20° C.) in a 500 mL beaker, and the mixture is stirred with a magnetic stirrer. A stirrer having a diameter of 5 mmφ and a length of 4 cm is used, and stirring is performed at a rotation speed of 500 rpm. Left after stirring for 5 minutes, the powdery sample floating on the water surface is confirmed, thereafter, methanol is added to the liquid surface at a rate of 20 g per minute. A point of time, when the powdery sample is dispersed in water and no sample is recognized on the liquid surface, is regarded as the end. An amount of methanol to be added is assumed to be A, and a hydrophobization degree is measured according to the following equation.
Hydrophobization degree (%)=A/(100+A)×100

8. The process for preparing a fluorine-containing elastomer composition of claim 7, wherein the hydrophobic treatment agent is at least one treating agent selected from the group consisting of a silylating agent, a silicone oil, and a silane coupling agent.

9. A molded article, which is obtained by crosslinking a fluorine-containing elastomer composition obtained by the preparation process of claim 7.
